(19) United States
(12) Patent Application Publication
(10) Pub. No.: US 2021/0342333 A1
(43) Pub. Date: Nov. 4, 2021

(54) PARTIAL UPDATES IN DATA COLLECTIONS IN A DATA STORAGE SYSTEM

(71) Applicant: International Business Machines Corporation, Armonk, NY (US)

(72) Inventors: Jacob McPherson, Franklinton, NC (US); Sean Ryan Lang, Cary, NC (US)

(21) Appl. No.: 16/866,081

(22) Filed: May 4, 2020

(51) Int. Cl. G06F 16/23; G06F 16/22; G06F 16/182

(52) U.S. Cl. CPC G06F 16/2379; G06F 16/182; G06F 16/2282; G06F 16/221

(57) ABSTRACT

A method and/or system of partially updating data in a data collection including determining, in a first incoming row of an incoming update file, whether a first incoming column contains new data, and in response using the new data in a first updated column of a first updated row in an updated master file; and in response to the first incoming column of the incoming update file not containing new data, determining whether a first master column in a first master row of the master table contains old data; and in response using the old data in the first updated column of the first updated row in the updated master file.

This disclosure relates generally to improved data management and processing for databases, including incremental or partial data drops. More specifically, the present disclosure relates to systems and methods for performing incremental or partial data drops and data updates in large data collections and databases, in computerized environments typical for analytical processing.

The use of electronic data storage is widespread. The relatively rapid increase in the amount of electronic data being created requires the storage and management of a large volume of electronic data. Large computer systems and network storage allow users to store and process large collections of data. Users and organizations that deal with significant quantities of digital information often have difficulty managing, searching, processing, and analyzing data in an efficient and intuitive manner. An inability to easily store, organize, search, locate, update, and manage data can translate into significant inefficiencies and lost opportunities.

In order to make good use of data, data needs to be efficiently stored and updated for processing. A number of different types of data storage systems can be used in data processing and storage systems for storing, sorting, organizing, managing, searching, updating, and locating data. One type of database storage system that has evolved is relational database systems. The architecture behind relational database systems is that data is organized in a highly structured manner following the relationship model. Another type of database is Not Only Structured Query Language databases, also referred to as “Not Only SQL” or “NoSQL” databases, which are unstructured in nature and provide an ability to flexibly load, store, and access data without having to define a schema ahead of time. Large organizations often rely upon distributed databases where data may be stored across multiple processing nodes, and often across multiple servers. The proliferation of network computing and storage has resulted in an increasingly large amount of data being stored which often needs updating.

Complete data records and files are needed for data analytics. Data is often provided as incomplete records and updates are provided over time as more information is collected. Updates and new data need to be reconciled with older records to use the most complete and up-to-date information. Current methods of updating records have proven inefficient resulting in Out-Of-Memory (OOM) errors. Systems, platforms, techniques, methods, and processes to efficiently perform incremental or partial data drops and/or update data and files to be included in large data collections, for example, to update master files, where the new data is reconciled with the old data is desirable.

### SUMMARY

The summary of the disclosure is given to aid understanding of data storage or information handling systems, their architectural structures, and their methods of storing, organizing, managing, and/or updating data and metadata residing on data storage systems, and not with an intent to limit the disclosure or the invention. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the data storage or information handling systems, their architectural structures, and their methods of operation to achieve different effects.

Methods, techniques, processes, systems, programming instructions, media containing program instructions, and/or platforms are disclosed for storing, managing, processing, and updating electronic data, including in an embodiment partial data updates to data collections in a data or file storage system. In one or more embodiments, methods, processes, techniques, programming instruction products, and/or systems of managing, handling, and/or updating data are disclosed. In one or more embodiments, a method, computer program product, and/or system of updating data in a master file of a file or data storage system is disclosed. The computer program product in an embodiment includes a machine readable medium storing instructions that, when executed by at least one programmable processor, cause the at least one programmable processor to perform operations as disclosed. A system is also disclosed that in an embodiment includes: at least one programmable processor; a database comprising a plurality of master files, each master file arranged and formatted as a master table having one or more master rows, wherein each master row has one or more master columns, at least one of the one or more master columns in one or more master rows containing old data; at least one user device for creating an update file, the update file arranged and formatted as a incoming table having one or more incoming rows, wherein each incoming row has one or more incoming columns, at least one of the one or more incoming columns in one or more incoming rows configured to contain new data input by a user using the at least one user device; and a machine-readable medium storing instructions that, when executed by the at least one programmable processor, cause the at least one programmable processor to perform operations as disclosed.

The method, computer program product, and/or system includes: (a) providing incoming data arranged as an incoming table corresponding to the master file, the incoming table having one or more incoming rows where each incoming row has one or more incoming columns, at least one of the one or more incoming columns in at least one or the one or more incoming rows has new data; (b) providing the master file arranged as a master table having one or more master rows where each master row has one or more master columns, at least one of the one or more master columns in at least one of the one or more master rows has old data; (c) determining, in a first incoming row of the one or more incoming rows of the incoming table, whether a first incoming column of the one or more incoming columns of the first incoming row contains new data, and in response to the first incoming column of the first incoming row containing new data, using the new data in a first updated column of a first updated row in an updated master file; (d) determining, in response to the first incoming column of the first incoming row not containing new data, whether a first master column in a first master row of the master table corresponding to the first incoming column of the first incoming row of the incoming table contains data; and (e) using, in response to the first master column in the first master row of the master table corresponding to the first incoming column of the first incoming row of the incoming table containing old data, the old data in the first updated column of the first updated row in the updated master file. The method, computer program product and/or system in an aspect includes not using, in response to the first master column in the first master row of the master table corresponding to the first incoming column of the first incoming row of the incoming table not containing old data, any data in the first updated column of the first updated row in the updated master file.

The method, computer programming product, and/or system further includes, in an aspect, creating the updated master file by performing the steps (c)-(e) for all the one or more incoming rows and all the one or more incoming columns of the incoming table and for all the one or more master rows and all the one or more master columns of the master table. In one or more embodiments, a filtering process is performed that includes comparing the first incoming row of the incoming table with the corresponding first master row of the corresponding master table, and in response to the first incoming row having one or more incoming columns of new data and the first master row corresponding to the incoming row having old data, identifying the first incoming row and the corresponding first master row as an updateable table row for updating, and in a further embodiment in response to (i) the first incoming row having one or more incoming columns of new data and the first master row corresponding to the incoming row having no data, or (ii) the first incoming row having no new data in any of the one or more incoming columns and the first master row corresponding to the incoming row having old data or no data, identifying the incoming row and the corresponding master row as an unupdateable table row that is not for updating. In a further aspect, steps (c)-(e) are performed on only the incoming rows and the corresponding master rows identified as updateable table rows to create updated table rows. In a further embodiment, a union process is performed that includes merging the updateable table rows with the unupdateable rows to create the updated master file, and in an aspect, merging the updated table rows with the unupdateable rows to create the updated master file.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

The various aspects, features and embodiments of data storage or information handling systems, their architectures, and the processing, storing, organizing, updating, and/or managing of data in data storage or information handling systems, will be better understood when read in conjunction with the figures provided. Embodiments are provided in the figures for the purpose of illustrating aspects, features, and/or various embodiments of the data storage or information handling systems, their architectural structures, and the processing, storing, updating, organizing, and/or managing data in data storage systems or databases, but the claims should not be limited to the precise arrangement, structures, features, aspects, assemblies, subassemblies, systems, circuitry, embodiments, or devices shown, and the arrangements, structures, assemblies, subassemblies, features, aspects, methods, processes, circuitry, embodiments, and devices shown may be used singularly or in combination with other arrangements, structures, assemblies, subassemblies, systems, features, aspects, circuitry, embodiments, methods and devices.

FIG. 1 depicts one example of a data processing or information handling system, also considered a computing environment, according to an embodiment of the present disclosure.

FIG. 2 is a functional block diagram illustrating a data processing or information handling system, according to an embodiment of the present disclosure.

FIG. 3 depicts an example block diagram of an information and data storage/management system, according to an embodiment of the present disclosure.

FIG. 4 is a diagrammatic illustration of an information system for updating data collections according to an embodiment of the present disclosure.

FIG. 5 is an example embodiment of a flow chart illustrating a method and technique of updating data in a data collection according to an embodiment of the present disclosure.

FIG. 6 is an example embodiment of a flow chart illustrating a method and technique for updating and squashing data in a data collection according to an embodiment of the present disclosure.

FIG. 7 is an example of data that has undergone the updating and squashing implementation of FIGS. 5 and 6.

FIG. 8 is an example embodiment of a flow chart illustrating a method and technique of updating data in a data collection according to another embodiment of the present disclosure.

FIG. 9 is a diagrammatic illustration of a system and/or mechanism for processing and updating information stored to a data collection according to an example implementation of the method and technique of FIG. 8.

FIG. 10 is an example of rows of data filtered during the method of FIG. 8 undergoing the updating and squashing technique of FIG. 6 according to an embodiment of the present disclosure.

FIG. 11 is a diagrammatic illustration of a system and/or mechanism for processing and updating information stored to a data collection according to an example implementation of the method and technique of FIG. 8.

### DETAILED DESCRIPTION

The following description is made for illustrating the general principles of the invention and is not meant to limit the inventive concepts claimed herein. In the following detailed description, numerous details are set forth in order to provide an understanding of data storage and information handling systems, their architectural structures, and/or methods of operation, including the processing, storing, updating, organizing, and/or managing data (and metadata), however, it will be understood by those skilled in the art that different and numerous embodiments of the data storage or information handling system, its architectural structure, and/or methods of operations, including the processing, storing, organizing, managing, and/or updating data and metadata may be practiced without those specific details, and the claims and disclosure should not be limited to the embodiments, structures, mechanisms, functional units, circuitry, assemblies, subassemblies, features, processes, methods, aspects, features or details specifically described and shown herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “content” or “data” means any computer-readable data including, but not limited to, digital photographs, digitized analog photos, music files, video clips, text documents, interactive programs, web pages, word processing documents, computer assisted design files, blueprints, flowcharts, invoices, database reports, database records, spread sheets, charts, tables, graphs, video game assets, sound samples, transaction log files, tables, electronic documents, files which simply name other objects, and the like. Data may include structured data (e.g., database files and objects), unstructured data (e.g., documents), and/or semi-structured data.

As used herein, the term “metadata” refers to any descriptive or identifying information in computer-processable form that is associated with particular content, data, or a data set. Generally speaking, content will have metadata that is relevant to a number of characteristics of the content and/or the overall content collection, including, but not limited to, the content's technical aspects (format, bytes used, date of creation), the workflow in which the content participates (creator, owner, publisher, date of publication, copyright information, etc) and the subject matter of the content (the nature of the sound of an audio file, be it music or a sound-effect, the subject of a photograph or video clip, the abstract of a lengthy text document, excerpted particulars of invoices or other data-interchange format files). For example, metadata items may include but are not limited to one or more of the following: the content owner (e.g., the client or user that generates the content), the creation time (e.g., creation time stamp), the last modified time (e.g., timestamp of the most recent modification of data), a data set name (e.g., a file name), a data set size (e.g., number of bytes of data set), information about the content (e.g., an indication as to the existence of a particular search term), table names, column headers including column family and column name, names user-supplied or custom metadata tags, to/from information for email (e.g., an email sender, recipient, etc.), creation date, file type (e.g., format or application type), last accessed time, application type (e.g., type of application that generated the data block), location/network (e.g., a current, past or future location of the data set and network pathways to/from the data block), geographic location (e.g., GPS coordinates), frequency of change (e.g., a period in which the data set is modified), business unit (e.g., a group or department that generates, manages or is otherwise associated with the set), aging information (e.g., a schedule, such as a time period, in which the data set is migrated to secondary or long term storage), boot sectors, partition layouts, file location within a file folder directory structure, user permissions, owners, groups, access control lists (ACLS), system metadata (e.g., registry information), combinations of the same or the other similar information related to the data set. The term “metadata tag”, or “metadata attributes” (also referred to as custom metadata tags or attributes) refers to any descriptive or identifying information in computer-processable form that is associated with particular metadata, and that is indicative of the actual information or the content included in various data storage systems and with which the metadata is associated. A metadata tag is also referred to as metadata attributes.

The following discussion omits or only briefly describes conventional features of data storage systems and information processing systems, data storage and management systems, their architectural structures, and/or methods of operation, including the processing, storing, organizing, managing, and/or updating data and metadata in data collections, which are apparent to those skilled in the art. It is assumed that those skilled in the art are familiar with the general architecture of data storage and information handling systems, data storage systems, their architectural structures, and/or their methods of operations, including the processing, storing, organizing, managing, and/or updating data in storage systems. It may be noted that a numbered element is numbered according to the figure in which the element is introduced, and is typically referred to by that number throughout succeeding figures.

Systems and/or methods according to one or more embodiments for storing, organizing, sorting, managing, processing, and/or updating data are disclosed. In one or more embodiments, systems, methods and/or techniques are disclosed for updating data in data collections. Complete data records and files are needed for data analytics. Data is often provided as incomplete records and updates are provided over time as more information is collected. Updates and new data need to be reconciled with older records to use the most complete and up-to-date information. Current methods of updating records have proven inefficient resulting in, for example, Out-Of-Memory (OOM) errors or other problems. Systems, platforms, techniques, methods, and processes are disclosed to perform incremental or partial data drops to be included in large data collections, for example, to master files, where the new data is reconciled with the old data. In one or more embodiments, upsert operations are performed on big data sets of flat files. In one or more embodiments, an input of data is made on a user device, such as, for example, a smart phone, a tablet, a lap top, or desk top computer, and the master file on a backend server is updated through squashing or update techniques and systems, and/or through filtering, squashing, and/or union techniques and systems as described below.

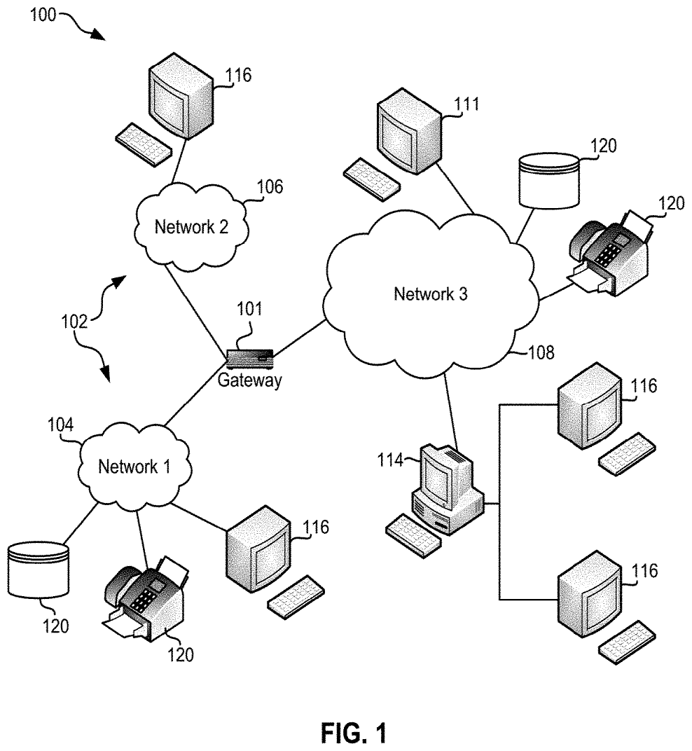

Turning to the environments in which the systems, platforms, methods, and techniques have potential application, FIG. 1 illustrates architecture 100 of a data processing or information handling system, also referred to as a computer network system, in accordance with an embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer, smartphone, or any other type of logic device. It should be noted that in an embodiment a user device 111 may also be directly coupled to any of the networks.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

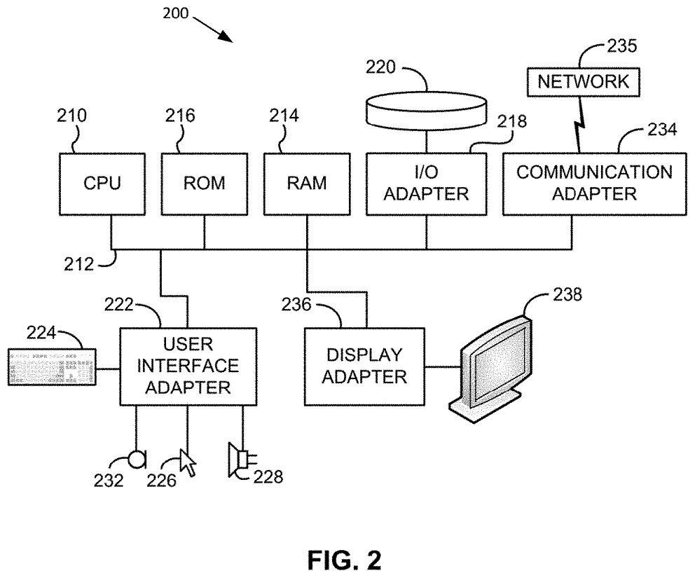

FIG. 2 shows a representative hardware environment associated with a user device 116 and/or server 114 of FIG. 1, in accordance with an embodiment. Such figure illustrates an example hardware configuration of a workstation 200 having a central processing unit 210, such as a microprocessor, and a number of other units interconnected via a system bus 212.

The workstation 200 shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), MAC OS, UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

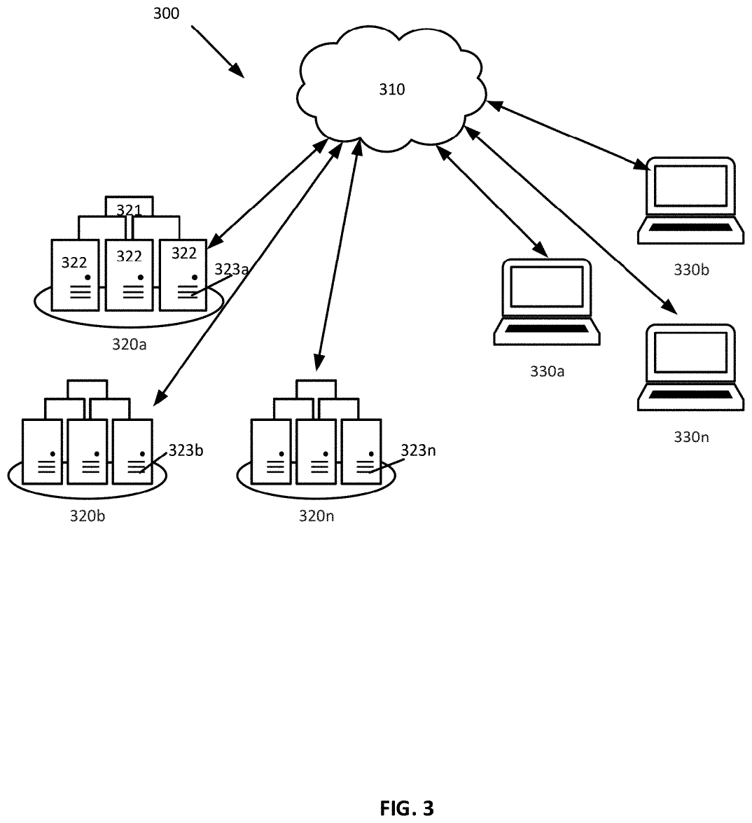

Referring now to FIG. 3, there is illustrated an example block diagram of an information management system 300 that includes a set of networked data storage systems 320a, 320b . . . 320n and client devices 330a, 330b . . . 330n in communication via a data network 310 and in accordance with implementations of this disclosure. It can be appreciated that the implementations disclosed herein are not limited by the number of storage devices or data storage systems attached to data network 310. It can be further appreciated that storage devices or data storage systems attached to data network 310 are not limited by communication protocols, storage environment, physical location, etc.

In one embodiment, each data storage system 320a, 320b . . . 320n may include a storage subsystem 321 and storage devices 322. The storage subsystem 321 may comprise a storage server or an enterprise storage server, such as the IBM Enterprise Storage Server®. (IBM and Enterprise Storage Server are registered trademarks of IBM). The storage devices 322 may comprise storage systems known in the art, such as a Direct Access Storage Device (DASD), Just a Bunch of Disks (JBOD), a Redundant Array of Independent Disks (RAID), a virtualization device, tape storage, optical disk storage, or any other data storage system. In certain embodiments, multiple storage subsystems may be implemented in one storage subsystem 321 and storage devices 322, or one storage subsystem may be implemented with one or more storage subsystems having attached storage devices. In an embodiment, data and metadata corresponding to contents of the storage systems 320a, 320b . . . 320n is collected and stored. Other types of information that generally provides insights into the contents of the storage systems 320a, 320b . . . 320n can also be stored.

In certain embodiments, client devices 330a, 330b . . . 330n may be general purpose computers having a plurality of components. These components may include a central processing unit (CPU), main memory, I/O devices, and data storage devices (for example, flash memory, hard drives and others). The main memory may be coupled to the CPU via a system bus or a local memory bus. The main memory may be used to provide the CPU access to data and/or program information that is stored in main memory at execution time. Typically, the main memory is composed of random access memory (RAM) circuits. A computer system with a CPU and main memory is often referred to as a host system. The client devices 330a, 330b . . . 330n can have at least one operating system (e.g., Microsoft Windows, Mac OS X, iOS, IBM z/OS, Linux, other Unix-based operating systems, etc.) installed thereon, which may support or host one or more file systems and other applications.

The data storage systems 320a, 320b . . . 320n and client devices 330a, 330b . . . 330n communicate according to well-known protocols, such as the Network File System (NFS) or the Common Internet File System (CIFS) protocols, to make content stored on data storage systems 320a, 320b . . . 320n appear to users and/or application programs as though the content were stored locally on the client systems 330a, 330b . . . 330n. In a typical mode of operation, the client devices 330a, 330b . . . 330n transmit one or more input/output commands, such as an NFS or CIFS request, over the computer network 310 to the data storage systems 320a, 320b . . . 320n, which in turn issues an NFS or CIFS response containing the requested content over the network 310 to the respective client devices 330a, 330b . . . 330n.

The client devices 330a, 330b . . . 330n may execute (internally and/or externally) one or more applications, which generate and manipulate the content on the one or more data storage systems 320a, 320b . . . 320n. The applications generally facilitate the operations of an organization (or multiple affiliated organizations), and can include, without limitation, mail server applications (e.g., Microsoft Exchange Server), file server applications, mail client applications (e.g., Microsoft Exchange Client), database applications (e.g., SQL, Oracle, SAP, Lotus Notes Database), word processing applications (e.g., Microsoft Word), spreadsheet applications(Microsoft Excel), financial applications, presentation applications, browser applications, mobile applications, entertainment applications, and so on. The applications may also have the ability to access (e.g., read and write to) data storage systems 320a, 320b . . . 320n using a network file system protocol such as NFS or CIFS. Other programs and applications may facilitate analytical processing of data such as Spark DataFrames and Pandas DataFrames.

As shown, the data storage systems 320a, 320b . . . 320n, the client devices 330a, 330b . . . 330n, and other components in the information management system 300 can be connected to one another via a communication network 310. The communication network 310 can include one or more networks or other connection types including any of following, without limitation: the Internet, a wide area network (WAN), a local area network (LAN), a Storage Area Network (SAN), a Fibre Channel connection, a Small Computer System Interface (SCSI) connection, a virtual private network (VPN), a token ring or TCP/IP based network, an intranet network, a point-to-point link, a cellular network, a wireless data transmission system, a two-way cable system, an interactive kiosk network, a satellite network, a broadband network, a baseband network, a neural network, a mesh network, an ad hoc network, other appropriate wired, wireless, or partially wired/wireless computer or telecommunications networks, combinations of the same or the like. The communication network 310 in some cases may also include application programming interfaces (APIs) including, e.g., cloud service provider APIs, virtual machine management APIs, and hosted service provider APIs.

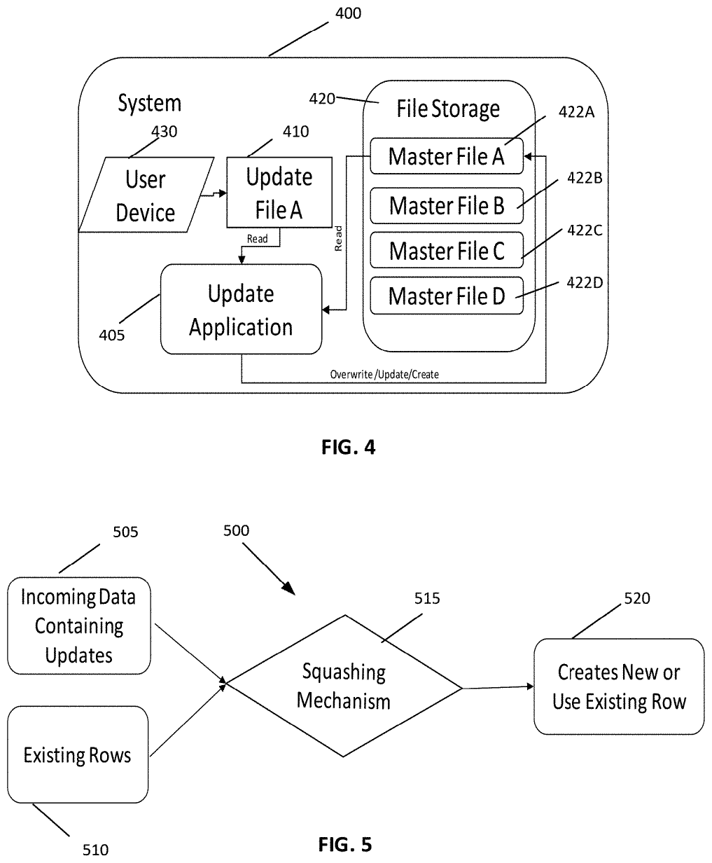

Referring to FIG. 4, an embodiment of an information handling system 400 having one or more User Devices 430, a file (data) storage system 420 and an Update Application 405 is diagrammatically illustrated. Information handling system 400 in FIG. 4 can have more or less systems, functional units, and/or components than shown. File storage system 420 has one or more Master Files 422, shown as Master Files A-D, where Master Files 422 are preferably configured and stored as flat files. While file storage system 420 is shown as having only four (4) Master Files 422A-422D, it can be appreciated that file storage system 420 can contain one or, more likely, many more Master Files 422. The Master Files 422 preferably are in tabular format, e.g., as a table with one or more rows having one or more columns of data, preferably where all rows contain the same number of columns and column names. File storage system 420 can be a server 114, e.g., a back end server 114, and/or data storage system 320, in one or more embodiments can have the components and circuitry of and/or be configured as workstation 200 in FIG. 2. Through User Device 430 a user/client inputs data to create Update File A (410) as shown in FIG. 4. User device 430 is shown as a single device, however, it should be appreciated that there can be one and more likely many more user devices 430 in information handling system 400. User device(s) 430 may comprise a smart phone, tablet, lap top computer, desk top computer or any other electronic instrument or data input device, such as for example user devices 111 and 116, and client devices 330. In one or more embodiments user device 430 has components and circuitry and/or is configured as workstation 200 in FIG. 2.

The Update Application 405 provides a system and method to update files, e.g., Master Files 422, on a file storage system, e.g., file (data) storage system 420. The Update Application 405 typically can execute on the same hardware that operates the file (data) storage system, which, for example, can be one or more of servers 114, workstation 200, and/or file (data) storage system 320. Update Application 405 reads the Update File A (410) and reads the corresponding Master File A (422A), which contains the old data previously saved to file storage system 420. The Update Application 405 updates the Master File A (422A) as will be described, and creates, overwrites, and/or updates the Master Files 422 on file storage system 420.

Referring now to FIG. 5, an exemplary flowchart in accordance with one or more embodiments illustrating and describing a method of updating and storing data to a data collection, preferably a file in a database or file storage system, for example file storage system 420, is disclosed. While the method 500 shown in FIG. 5 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 5, but the process may be integrated and/or one or more steps may be performed together, simultaneously, or the steps may be performed in the order disclosed or in an alternate order, unless indicated otherwise.

At 505 in process 500 the Update Application 405 is provided with incoming data as Update File 410. If a Master File, e.g., Master File 422, does not already exist on file storage 420 corresponding to Update File 410, the incoming Update File 410 and data is saved and treated as the Master File, e.g., becomes the Master File 422. In one or more embodiments, the incoming data at 505 is input by a user through User Device 330, and provided to Update Application 405, and in an aspect the Update Application 405 reads the Update File 410. The Master File, e.g., Master File 422, and in an aspect the existing rows of the Master File, is provided at 510. In an aspect, at 510 the existing Master File, e.g., Master File 422A, corresponding to the Update File 410 is provided to Update Application 405, and in an embodiment Update Application 405 reads the existing Master File, e.g., Master File 422A, and preferably reads existing rows of the corresponding Master File, e.g., reads the existing rows of Master File 422A.

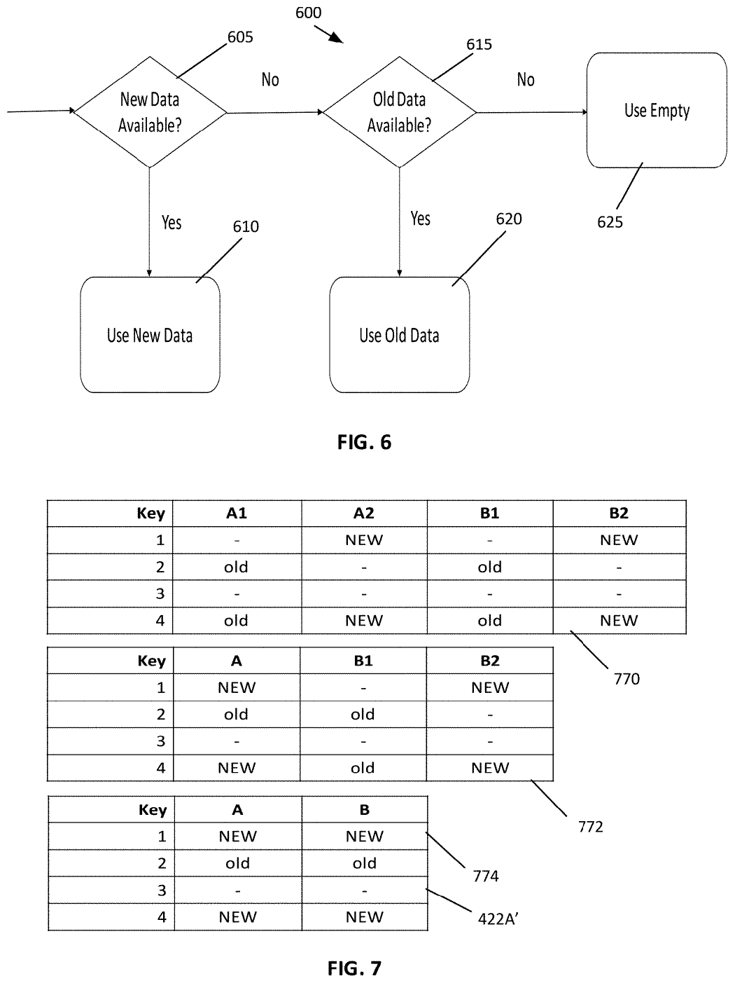

At 515 a squashing mechanism or operation is applied to the incoming data in the Update File 410 and the existing data as provided in Master File 422A. The squashing mechanism or operation 515 is shown in more detail in FIG. 6 as process 600. In squashing process 600, it is determined at 605 whether new data in a column in a row is available. For example, it is determined if Update File 410 has data in a respective column in a row. In an aspect, if new data is available (605: Yes), then at 610 the new data is used in the column in the row of the Master File 422. If new data is not available in the column of the row (605: No), then the process 600 of squashing the rows in the Master File 422 continues to 615 where it is determined whether old data is available from the Master File 422A for the column of the row to be updated. If at 615 it is determined that old data in a column of the row is available (615: Yes), then at 620 the old data is used in the column in the row. If at 615 it is determined that old data in the column is not available (615: No), then at 625 the column is left empty. The squashing process 600 of FIG. 6 in an embodiment continues for each row squashing columns of data, and at 520 creates a new row (e.g., a completely new row, or a row with new data in one or more columns) from the data from Update File 410, or uses an existing row of data from the Master File 422 to create an updated Master File 422A′.

FIG. 7 is a diagrammatic illustration of squashing mechanism 515/600 according to a first implementation where all columns of data in all rows are reviewed and squashed or updated to create a new or updated Master File 422A′. In table 770 columns A1 and B1 represent columns A and B in existing Master File 422A saved in data file storage 420, while columns A2 and B2 represent columns A and B in Update File 410. As illustrated by table 770 new data is being added in columns A and B in rows 1 and 4 by Update File 410. Table 772 represents the partially updated Master File after the data in column A in rows 1-4 of the Update File 410 have been updated and squashed with the data in column A in rows 1-4 of the Master File 422A. Table 774 represents the updated Master File 422A′ after the data in column B in rows 1-4 of the Update File 410 have been updated and squashed with the data in column B in rows 1-4 in Master File 422A. The updated Master File 422A′ is written to (saved in) data storage 420 as new Master File 422A. The squashing mechanism and process 600 is applied to every row regardless of whether it needs updating so in the updating process 600, rows 1 and 4 which need updating as well as rows 2 and 3 that do not need updating undergo the squashing or updating process 600.

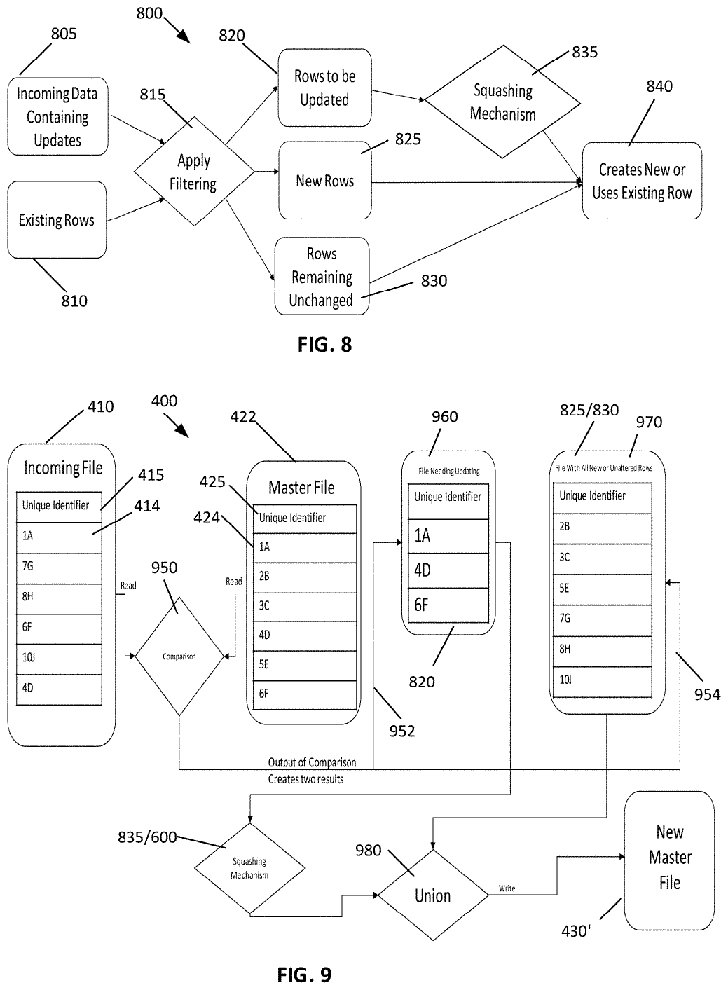

Referring now to FIG. 8, an exemplary flowchart in accordance with one or more embodiments illustrating and describing a method of updating and storing data to a data collection, preferably a file in a database or file storage system, for example file storage system 420, is disclosed. While the method 800 shown in FIG. 8 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 8, but the process may be integrated and/or one or more steps may be performed together, simultaneously, or the steps may be performed in the order disclosed or in an alternate order, unless indicated otherwise.

At 805 in process 800 the Update Application, e.g., Update Application 405, is provided with incoming data as an Update File 410. If a Master File, e.g., Master File 422, does not already exist on file storage system 420, the incoming Update File 410 and data is saved and treated as the Master File, e.g., becomes the Master File 422. In one or more embodiments, the incoming data at 805 is input by a user through User Device 430, and provided to Update Application 405, and in an aspect the Update Application 405 reads the Update File 410. The Master File, e.g., Master File 422, and in an aspect the existing rows of data in the Master File, is provided at 810. In an aspect, at 810 the existing Master File, e.g., Master File 422A, corresponding to the Update File 410 is provided to Update Application 405, and in an embodiment Update Application 405 reads the existing Master File, e.g., Master File 422A, and preferably reads existing rows of the corresponding master file, e.g., reads the existing rows of Master File 422A.

The process 800 continues at 815 where a filtering process is applied to the incoming Update File 410 and the corresponding Master File 422 to determine or identify: at 820 which rows in the Master File 422 need updating; at 825 which rows in Update File 410 are new and do not exist in the Master File 422; and at 830 which rows in the Master File 422 remain unchanged by Update File 410. Filtering process 900 performed and applied at 815, 820, 825, and 830 is shown in an example in more detail with reference to diagrammatic system/process of FIG. 9. In FIG. 9, incoming Update File 410 and Master File 422 are read as per processes 805 and 810, and at 815 in one or more aspects Update File 410 and Master File 422 are compared in comparator 950. That is, in an embodiment the incoming Update File 410 and the Master File 422 are files that are read into memory and the two files are compared. In one or more embodiments, comparison of incoming Update File 410 with Master File 422 is performed on a row-by-row basis. In one or more embodiments, the comparator 950 has and/or uses circuitry and logic to perform the comparison process described. As shown in FIG. 9 each row 414 in incoming Update File 410 has a unique identifier 415 and each row 424 in Master File 422 has a unique identifier 425. In comparator 950, a unique row identifier 415 from Update File 410 is searched for a corresponding unique row identifier 425 from Master File 422 (or vice versa—Update File 410 is searched). If a unique row identifier 415 is found in Update File 410 and no corresponding unique row identifier 425 is found in Master File 422, then a new row 414 from Update File is identified at 825 as shown in FIGS. 8 and 9. If a unique row identifier 425 is located in Master File 422 and no corresponding unique row identifier 415 is found in Update File 410, then the existing row 424 from Master File 422 is identified at 830 in FIGS. 8 and 9.

In an embodiment, as shown in FIG. 9, the output of the comparison performed by comparator 950 creates two results, a first output 952 identifying rows of data that need updating, and a second output 954 of existing rows or new rows of data. In the example of FIG. 9, incoming Update File 410 to Update Application 405 contains data in rows with unique row identifiers 1A, 7G, 8H, 6F, 10J and 4D, while corresponding Master File 422 contains data in rows with unique identifiers 1A, 2B, 3C, 4D, 5E and 6F. Applying filtering via comparison by comparator 950, rows with unique identifiers 1A, 4D and 6F are identified at 820 as rows in the Master File 422 that need updating and in an aspect are sent to file/register/cache 960, whereas rows with unique identifiers 2B, 3C, 5E, 7G, 8H and 10J are identified as new rows at 825 or existing rows at 830, and in an aspect are sent to file/register/cache 970.

The filtering at 815 in an aspect identifies at 820 the rows of data in the Master File 422 to be updated by Update File 410, and in an aspect sends those rows to file/register/cache 960. In an embodiment, if at 815 the filtering, e.g., the comparison performed at 950, identifies and/or finds a unique row identifier 415 in Update File 410 where the same unique row identifier 425 exists in Master File 422 then a row of data in the Master File 422 for updating is identified at 820. In an embodiment, the rows of data needing updating are sent to file/register/cache 960. Additionally, or alternatively, the rows identified as needing updating at 820 and as a result of the filtering 950 in FIG. 9 are sent to squashing mechanism 835. A process and method 835 of updating and squashing rows is shown in process 600 in FIG. 6. In the squashing mechanism 835 in FIG. 9, the rows from file/register 960, e.g., the output 952 of comparator 950 (the comparison performed at 950), are processed in the squashing process 600 of FIG. 6. In the process 800 for the implementation shown in FIG.8, in an aspect the squashing process 600 of FIG. 6 is applied only to the rows that have updated columns of data. At 605 it is determined whether new data in a column in the row is available. For example, since the rows were subject to a filtering/comparison process at 815, the row should have one or more columns of new data from Update File 410. In an aspect, if new data is available (605: Yes), then at 610 the new data is used in the column in the row. If new data is not available in the column of the row (605: No), then the process 600 of updating the rows continues to 615 where it is determined whether old data is available from the Master File 422A in the column of the row being processed. If at 615 it is determined that old data in a column of the row is available (615: Yes), then at 620 the old data is used in the column in the row being processed. If at 615 it is determined that old data in the column is not available (615: No), then at 625 the column is left empty.

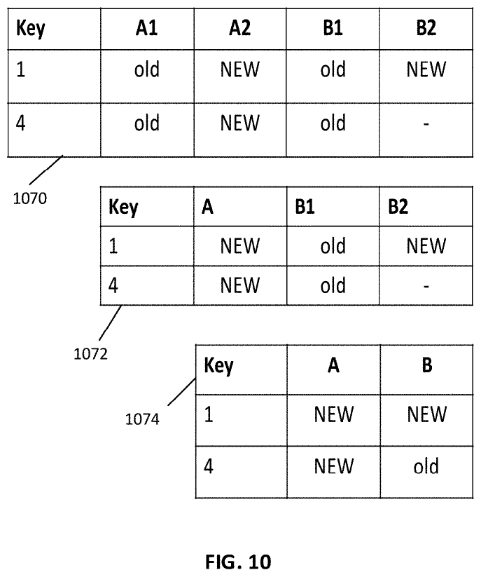

It should be appreciated, that as a result of filtering process at 815, the squashing mechanism 835, also referred to as an update process, is only applied in process 800 to those rows that had update data in the Update File 410. Only those rows that were updated with new data are input to squashing mechanism 835 in FIG. 9. FIG. 10 diagrammatically illustrates the process and results of an example of the operations of the squashing mechanism 835 of FIG. 9 where the data from rows 1 and 4 of the Update File 410 and the Master File 422 are fed into the squashing mechanism 835. In FIG. 10, in table 1070 columns A1 and B1 represent columns A and B in existing Master File 422A saved in data file storage 420, while columns A2 and B2 represent columns A and B in Update File 410. As illustrated by table 1070, new data is being added in columns A2 and B2 (columns A & B) of row 1, and new data is being added in column A2 (column A) of row 4. Table 1072 represents the partially updated Master File after the data in column A in rows 1 and 4 of the Update File 410 has been updated and squashed with the data in column A in rows 1 and 4 of the Master File 422A. Table 1074 represents the updated Master File 422A′ after the data in column B in row 1 of the Update File 410 have been updated and squashed with the data in column B in row 1 in Master File 422A, while the old data from column B of the Master File 422A remains after the quashing operation 835.

At 840, the squashed columns of data, e.g., the updated rows from block 835 are merged with the new rows from block 825 and the existing rows at 830 to create updated rows of data in Master File 422. In an embodiment, the process 840, includes, as shown in FIG. 9, the updated rows, e.g. table 1074, output by the squashing mechanism 835 are fed to union mechanism 980 in FIG. 9. In addition, existing rows from process 830 and new rows from process 825 in file/register/cache 970 are input to union mechanism 980. The updated rows from table 1074 are added in union mechanism 980 to the existing rows and added rows from file/register/cache 970. The output of union mechanism 980 is written to file storage system 420 as updated Master File, e.g., updated or new Master File 422A′, and becomes Master File 422.

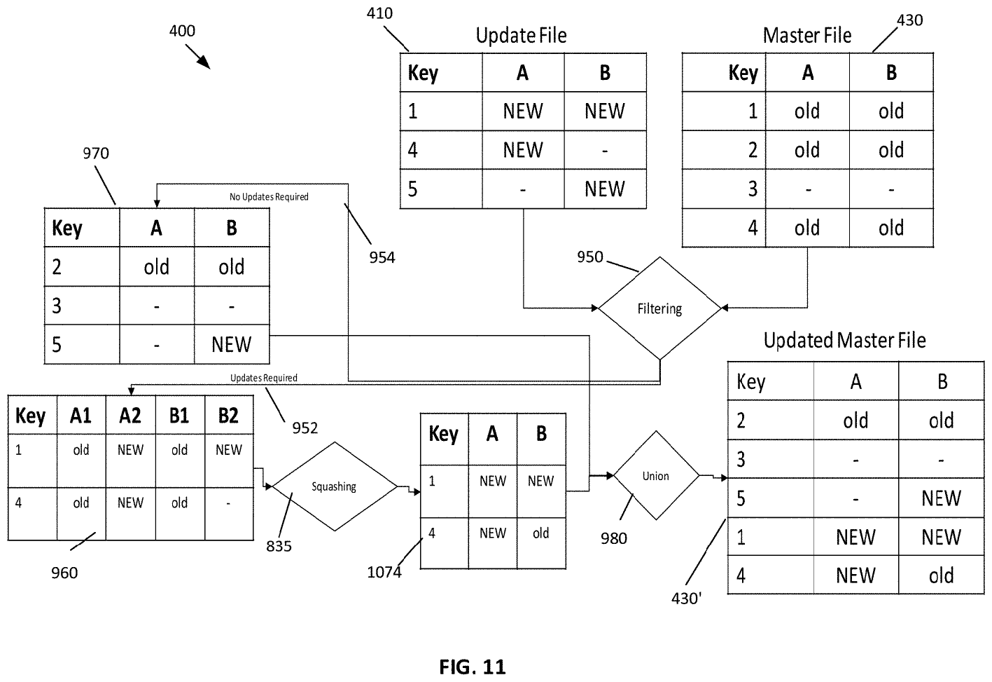

FIG. 11 illustrates an example of a user updating a file where the user creates a File Update 410. In system 400, a comparison or filtering is performed at 950 between the incoming file, e.g., Update File 410 and the Master File 422 in data storage 420. The result of the comparison or filtering at 950 are rows of Update file 410 and corresponding rows of Master File 422 sent to register/cache 960 via 952 for rows that need updating, and rows of Update file 410 or Master File 422 sent to register/cache 970 via 954 for rows that do not need updating. As row 2 contains only old data, row 3 contains no data, and row 5 only contains new data, rows 2, 3 and 5 are sent to register/cache 970. As rows 1 and 4 of Update File 410 contain new data and corresponding rows 1 and 4 of Master File 422 contain data, rows 1 and 4 of Update File 410 and Master File 422 are sent to register/cache 960. Rows 1 and 4 in register/cache 960 undergo quashing operation at 835 to create updated rows 1 and 4 as illustrated by table 1074 in FIG. 11. Rows 2, 3, 5 are sent from register/cache 970, while updated rows 1 and 4 are sent from squashing mechanism/process 835 to union mechanism 980, and the output of union mechanism/process 980 is merged rows 1-5, which are written and stored as updated Master File 422A′ to storage.

While illustrative embodiments described above can be implemented in hardware, such as in units and circuitry of a processor, various aspects of the illustrative embodiments are implemented in software. For example, it will be understood that each block of the flowchart illustration in FIGS. 5, 6, and 8, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

In one or more embodiments a computer program product is disclosed. The computer program product can be embodied on one or more computer-readable media and include programming instructions that when executed cause the operations and processing of Update Application 410. In an embodiment, the process written as pseudo code includes in a first implementation, in an aspect: (1) Input: DataFrame A, DataFrame B, Keys k_1 . . . k_N, [Where columns(A)==columns(B) and k_1 . . . k_N\in columns(A)]; (2) Rename B columns (excepting k_1 . . . k_N) to a safe name to avoid naming collisions, for column c_i in {columns(B)\setminus {k_1 . . . k_N}}: Rename B[c_i] to B[temp(c_i)]; (3) Align rows using full outer join on equivalencies between k_1 . . . k_N, Joined=full_outer_join(A,B, on={k1 . . . k_N}); (4) “Squash” columns together taking B's information with priority, where for column c_i in {columns(A)\setminus {k_1 . . . k_N}}: if exists(B[temp(c_i)]): then Final[c_i]<−B[temp(c_i)], Else Final[c_i]<−A[c_i]; and (5) Output: DataFrame Final, where each row present represents the most up-to-date information. In an embodiment, the process written as psuedo code includes in a second implementation, in an aspect: (1) Input: DataFrame A, DataFrame B, Keys k_1 . . . k_N, [where columns(A)==columns(B) and k_1 . . . k_N\in columns(A)]; (2) Rename B columns (excepting k_1 . . . k_N) to a safe name to avoid naming collisions, for column c_i in {columns(B)\setminus {k_1 . . . k_N}}: Rename B[c_i] to B[temp(c_i)]; (3) Perform an inner join to retrieve only those rows which present a conflict, InnerJoined<−inner_join(A,B, on={k_1 . . . k_N}); (4) On the inner group, perform the same “squashing” operation as found in step 4 in the first implementation, SquashedInner<−squash(InnerJoined); (5) Perform an outer excluding join between A and B (without original column names in-tact) to get those rows which do NOT present a conflict, OuterJoined<−outer_excluding_join(A,B, on={k_1 . . . k_N}); (6) Calculate the union of the two separately-joined dataframes, Final<−union(SquashedInner, OuterJoined); and (7) Output: Final where the conditions are met.

Accordingly, blocks of the flowchart illustration support combinations of means for performing the specified functions, combinations of steps for performing the specified functions, and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

One or more embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a field programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

The corresponding structures, materials, acts, and equivalents of all means or step plus function elements in the claims below are intended to include any structure, material, or act for performing the function in combination with other claimed elements as specifically claimed. The description of the embodiments of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The embodiments and examples were chosen and described in order to best explain the principles of the disclosure and the practical application, and to enable others of ordinary skill in the art to understand the disclosure for various embodiments with various modifications as are suited to the particular use contemplated.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

It will be clear that the various features of the foregoing systems and/or methodologies may be combined in any way, creating a plurality of combinations from the descriptions presented above.

It will be further appreciated that embodiments of the present disclosure may be provided in the form of a service deployed on behalf of a customer to offer service on demand.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of updating data in a master file of a file storage system comprising:
(a) providing incoming data arranged as an incoming table corresponding to the master file, the incoming table having one or more incoming rows where each incoming row has one or more incoming columns, at least one of the one or more incoming columns in at least one or the one or more incoming rows has new data;
(b) providing the master file arranged as a master table having one or more master rows where each master row has one or more master columns, at least one of the one or more master columns in at least one of the one or more master rows has old data;
(c) determining, in a first incoming row of the one or more incoming rows of the incoming table, whether a first incoming column of the one or more incoming columns of the first incoming row contains new data, and in response to the first incoming column of the first incoming row containing new data, using the new data in a first updated column of a first updated row in an updated master file;
(d) determining, in response to the first incoming column of the first incoming row not containing new data, whether a first master column in a first master row of the master table corresponding to the first incoming column of the first incoming row of the incoming table contains data; and
(e) using, in response to the first master column in the first master row of the master table corresponding to the first incoming column of the first incoming row of the incoming table containing old data, the old data in the first updated column of the first updated row in the updated master file.

2. The method according to claim 1, further comprising not using, in response to the first master column in the first master row of the master table corresponding to the first incoming column of the first incoming row of the incoming table not containing old data, any data in the first updated column of the first updated row in the updated master file.

3. The method according to claim 1, further comprising creating the updated master file by performing the steps (c)-(e) of claim 1 for all the one or more incoming rows and all the one or more incoming columns of the incoming table and for all the one or more master rows and all the one or more master columns of the master table.

4. The method according to claim 3, further comprising performing the steps of claim 2 for all the one or more incoming rows and all the one or more incoming columns of the incoming table and for all the one or more master rows and all the one or more master columns of the master table.

5. The method according to claim 2, further comprising applying a filtering process comprising: comparing the first incoming row of the incoming table with the corresponding first master row of the corresponding master table, and in response to the first incoming row having one or more incoming columns of new data and the first master row corresponding to the incoming row having old data, identifying the first incoming row and the corresponding first master row as an updateable table row for updating.

6. The method according to claim 5, further comprising:
performing a filtering process comprising: comparing the first incoming row of the incoming table with the corresponding first master row of the corresponding master table; and
in response to (a) the first incoming row having one or more incoming columns of new data and the first master row corresponding to the incoming row having no data, or (b) the first incoming row having no new data in any of the one or more incoming columns and the first master row corresponding to the incoming row having old data or no data, identifying the incoming row and the corresponding master row as an unupdateable table row that is not for updating.

7. The method according to claim 5, further comprising:
performing the filtering process to each of the one or more incoming rows of the incoming table and to each of the one or more master rows of the master table to: (a) identify all the incoming rows and all the corresponding master rows as the updateable table rows for updating; and (b) identify all the incoming rows and all the corresponding master rows as the unupdateable table rows not for updating; and
performing steps (c)-(e) of claim 1 to only the incoming rows and the corresponding master rows identified as updateable table rows to create updated table rows.

8. The method according to claim 6, further comprising:
performing the filtering process to each of the one or more incoming rows of the incoming table and to each of the one or more master rows of the master table to: (a) identify all the incoming rows and all the corresponding master rows as the updateable table rows for updating; and (b) identify all the incoming rows and all the corresponding master rows as the unupdateable table rows not for updating; and
performing a union process comprising merging the updateable table rows with the unupdateable rows to create the updated master file.

9. The method according to claim 7, further comprising performing a union process comprising merging the updated table rows with the unupdateable rows to create the updated master file.

10. The method according to claim 9, further comprising writing the updated master file to the file storage system.

11. A computer program product comprising a machine readable medium storing instructions that, when executed by at least one programmable processor, cause the at least one programmable processor to perform operations comprising:
(a) providing incoming data arranged as an incoming table corresponding to the master file, the incoming table having one or more incoming rows where each incoming row has one or more incoming columns, at least one of the one or more incoming columns in at least one or the one or more incoming rows has new data;
(b) providing the master file arranged as a master table having one or more master rows where each master row has one or more master columns, at least one of the one or more master columns in at least one of the one or more master rows has old data;
(c) determining, in a first incoming row of the one or more incoming rows of the incoming table, whether a first incoming column of the one or more incoming columns of the first incoming row contains new data, and in response to the first incoming column of the first incoming row containing new data, using the new data in a first updated column of a first updated row in an updated master file;
(d) determining, in response to the first incoming column of the first incoming row not containing new data, whether a first master column in a first master row of the master table corresponding to the first incoming column of the first incoming row of the incoming table contains data; and
(e) using, in response to the first master column in the first master row of the master table corresponding to the first incoming column of the first incoming row of the incoming table containing old data, the old data in the first updated column of the first updated row in the updated master file.

12. The computer program product according to claim 11, further comprising instructions that, when executed by the at least one programmable processor, cause the at least one programmable processor to perform operations comprising:
not to use, in response to the first master column in the first master row of the master table corresponding to the first incoming column of the first incoming row of the incoming table not containing old data, any data in the first updated column of the first updated row in the updated master file.

13. The computer program product according to claim 11, further comprising instructions that, when executed by the at least one programmable processor, cause the at least one programmable processor to perform operations comprising:
creating the updated master file by performing the steps (c)-(e) of claim 11 for all the one or more incoming rows and all the one or more incoming columns of the incoming table and for all the one or more master rows and all the one or more master columns of the master table.

14. The computer program product according to claim 13, further comprising instructions that, when executed by the at least one programmable processor, cause the at least one programmable processor to perform operations comprising:
performing the steps of claim 12 for all the one or more incoming rows and all the one or more incoming columns of the incoming table and for all the one or more master rows and all the one or more master columns of the master table.

15. The computer program product according to claim 12, further comprising instructions that, when executed by the at least one programmable processor, cause the at least one programmable processor to perform operations comprising:
applying a filtering process comprising: comparing the first incoming row of the incoming table with the corresponding first master row of the corresponding master table, and in response to the first incoming row having one or more incoming columns of new data and the first master row corresponding to the incoming row having old data, identifying the first incoming row and the corresponding first master row as an updateable table row for updating.

16. The computer program product according to claim 15, further comprising instructions that, when executed by the at least one programmable processor, cause the at least one programmable processor to perform operations comprising:
performing a filtering process comprising comparing the first incoming row of the incoming table with the corresponding first master row of the corresponding master table; and
in response to (a) the first incoming row having one or more incoming columns of new data and the first master row corresponding to the incoming row having no data, or (b) the first incoming row having no new data in any of the one or more incoming columns and the first master row corresponding to the incoming row having old data or no data, identifying the incoming row and the corresponding master row as an unupdateable table row that is not for updating.

17. The computer program product according to claim 15, further comprising instructions that, when executed by the at least one programmable processor, cause the at least one programmable processor to perform operations comprising:
performing the filtering process to each of the one or more incoming rows of the incoming table and to each of the one or more master rows of the master table to: (a) identify all the incoming rows and all the corresponding master rows as the updateable table rows for updating; and (b) identify all the incoming rows and all the corresponding master rows as the unupdateable table rows not for updating; and
performing steps (c)-(e) of claim 11 to only the incoming rows and the corresponding master rows identified as updateable table rows to create updated table rows.

18. The computer program product according to claim 16, further comprising instructions that, when executed by the at least one programmable processor, cause the at least one programmable processor to perform operations comprising:
performing the filtering process to each of the one or more incoming rows of the incoming table and to each of the one or more master rows of the master table to: (a) identify all the incoming rows and all the corresponding master rows as the updateable table rows for updating; and (b) identify all the incoming rows and all the corresponding master rows as the unupdateable table rows not for updating; and
performing a union process comprising merging the updateable table rows with the unupdateable rows to create the updated master file.

19. The computer program product according to claim 17, further comprising instructions that, when executed by the at least one programmable processor, cause the at least one programmable processor to perform operations comprising:
performing a union process comprising merging the updated table rows with the unupdateable rows to create the updated master file; and
writing the updated master file to the file storage system.

20. A system comprising:
at least one programmable processor;
a database comprising a plurality of master files, each master file arranged and formatted as a master table having one or more master rows, wherein each master row has one or more master columns, at least one of the one or more master columns in one or more master rows containing old data;
at least one user device for creating an update file, the update file arranged and formatted as a incoming table having one or more incoming rows, wherein each incoming row has one or more incoming columns, at least one of the one or more incoming columns in one or more incoming rows configured to contain new data input by a user using the at least one user device;
a machine-readable medium storing instructions that, when executed by the at least one programmable processor, cause the at least one programmable processor to perform operations comprising:
(a) determining, in a first incoming row of the one or more incoming rows of the incoming table, whether a first incoming column of the one or more incoming columns of the first incoming row contains new data, and in response to the first incoming column of the first incoming row containing new data, using the new data in a first updated column of a first updated row in an updated master file;
(b) determining, in response to the first incoming column of the first incoming row not containing new data, whether a first master column in a first master row of the master table corresponding to the first incoming column of the first incoming row of the incoming table contains data;
(c) using, in response to the first master column in the first master row of the master table corresponding to the first incoming column of the first incoming row of the incoming table containing old data, the old data in the first updated column of the first updated row in the updated master file; and
(d) not using, in response to the first master column in the first master row of the master table corresponding to the first incoming column of the first incoming row of the incoming table not containing old data, any data in the first updated column of the first updated row in the updated master file.
